(19) United States
(12) Patent Application Publication
(10) Pub. No.: US 2003/0222424 A1
(43) Pub. Date: Dec. 4, 2003

(54) Bicycle capable of being folded twice for storage and carrying

(76) Inventor: Bill Huang, Chang-hua (TW)

Correspondence Address: Bill Huang, 235 Chung-Ho, Box 8-24, Taipei, TW

(21) Appl. No.: 10/158,448

(22) Filed: May 31, 2002

(51) Int. Cl. B62K 15/00

(52) U.S. Cl. 280/287

(57) ABSTRACT

A bicycle capable of being folded twice for storage and carrying comprises a frame body, a chain driving unit, a control unit, and a cushion unit. One end of the frame body is formed with a pivotal hole for being engaged with a locking screw and an opening hole for being engaged with a quick-detaching screw. Thereby, the lock frame body and the telescopic rod are connected by the two screws so that the frame body is foldable with respect to the telescopic rod. The similar structures are used to lock the frame body and the cushion unit so that the frame body is foldable with respect to the cushion unit. As a result, a bicycle capable of being folded twice for storage and carrying can be realized by above-mentioned structure.

### FIELD OF THE INVENTION

The present invention relates to bicycles, and particularly to a bicycle capable of being folded twice for storage and carrying, wherein the body of the bicycle can be folded twice for reducing the volume so that it can be storage and carried out conveniently.

### BACKGROUND OF THE INVENTION

Currently, bicycles have become popular tools both in exercising and traveling. It is frequently occurred that the bicycle must be carried by the user or placed in the car storage box. Thereby, the bicycle must have a compact outlook and is foldable for being stored easily. Alternatively, commercial foldable bicycles are developed for many years, while these prior arts are only folded once so that the handle and cushion of the bicycles can not be hidden and thus the frame body can be not effectively reduced. Moreover, the frame body is still too large to be reduced to a required volume.

### SUMMARY OF THE INVENTION

Accordingly, the primary object of the present invention is to provide a bicycle capable of being folded twice for storage and carrying, wherein the body of the bicycle can be folded twice for reducing the volume so that it can be storage conveniently.

To achieve above objects, the present invention provides a bicycle capable of being folded twice for storage and carrying comprising a frame body, a chain driving unit, a control unit, and a cushion unit.

One end of the frame body with respect to the control unit is formed with a pivotal hole and an opening hole. The pivotal hole serves for being installed by a locking screw. The opening hole serves for being installed by the quick-detaching screw. The locking screw serves to pivotally lock the frame body with the telescopic rod so that the frame body and the telescopic rod are fixed and pivotally connected with one another. The quick-detaching screw serves to separably and pivotally engage the frame body with the telescopic rod. Thereby, the control unit can be bent with respect to the frame body through an angle.

The cushion unit is formed by a cushion body and a cushion rod. The cushion rod is a telescopic and foldable rod. One end of the cushion rod with respect to the frame body is installed with a second locking screw and a second quick-detaching screw. One end of the frame body with respect to the cushion rod has a second pivotal hole and a second opening hole. The second pivotal hole is inserted by the second locking screw so as to pivotally lock the frame body and the cushion rod. The second opening hole is inserted by the second quick-detaching screw so as to separably and pivotally engage the frame body and the cushion rod. Thereby, the cushion unit can be bent with respect to the frame body through an angle.

The various objects and advantages of the present invention will be more readily understood from the following detailed description when read in conjunction with the appended drawing.

### BRIEF DESCRIPTION OF THE DRAWINGS

FIG. 1 is an assembly schematic view of the present invention.

FIG. 2 is an assembled cross sectional view of the present invention.

FIG. 3 shows the operation of folding the bicycle according to the present invention.

FIG. 4 is a schematic view showing the appearance of the present invention after it is folded.

FIG. 5 is another schematic view showing the appearance of the present invention after it is folded.

### DETAILED DESCRIPTION OF THE PREFERRED EMBODIMENTS

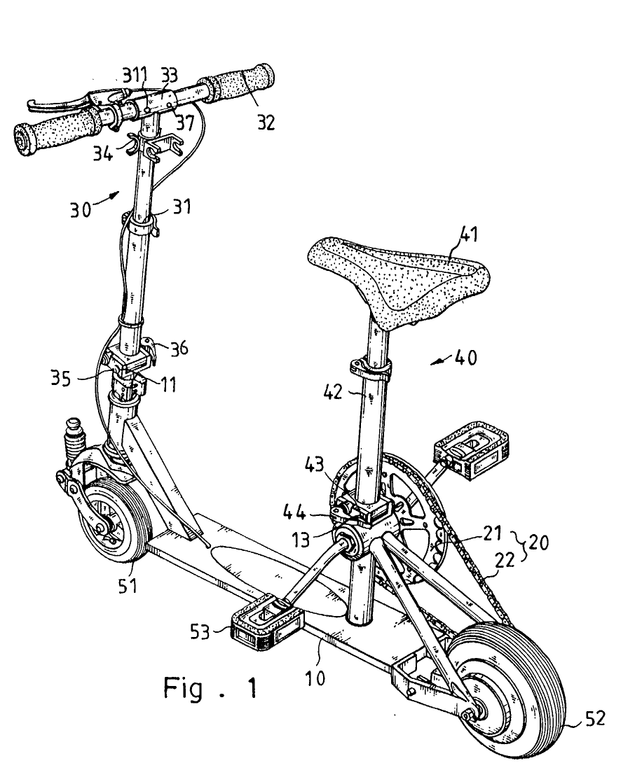

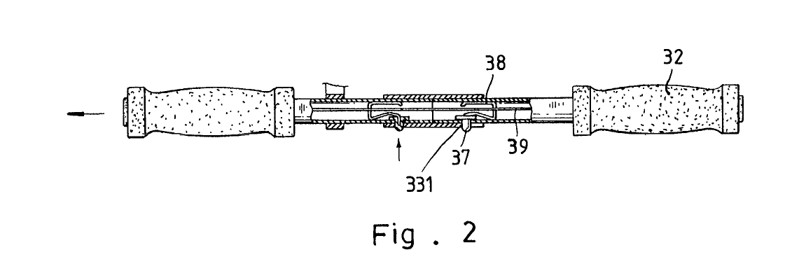

Referring to FIGS. 1 and 2, the bicycle capable of being folded twice for storage and carrying according to the present invention is illustrated. The bicycle of the present invention mainly comprises a frame body 10, a chain driving unit 20, a control unit 30, and a cushion unit 40.

The frame body 10 is a long plate and has a front wheel 51, a rear wheel 52, pedals 53 etc.

The chain driving unit includes a driving gear 21 and a chain 22 for generating power for moving forwards.

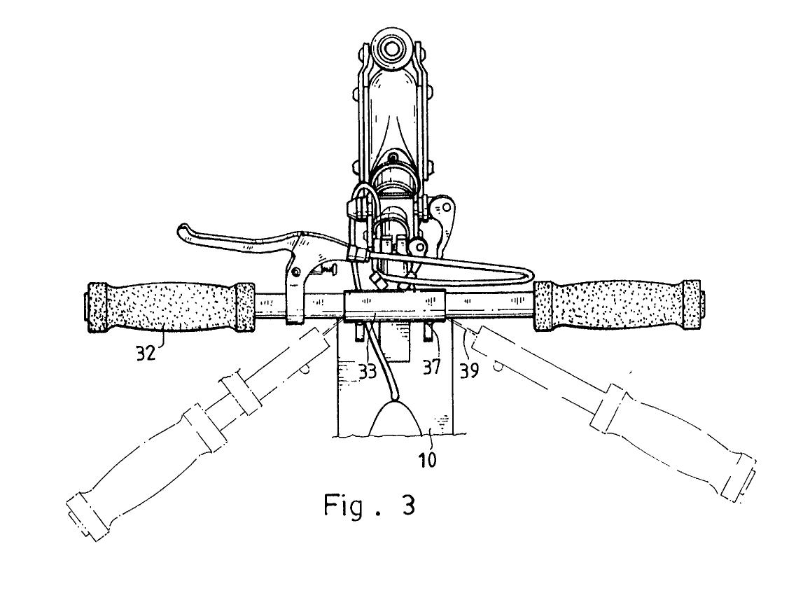

The control unit 30 has a telescopic rod 31 and two handles 32. The upper section of the telescopic rod 31 is installed with a transversal tube 33 and two positioning bodies 34, and a lower end thereof is installed with a locking screw 35 and a quick-detaching screw 36. The two handles 32 have respective position buttons 37 at predetermined positions. The inner surface of each position button 37 is resisted by an elastomer 38. Thereby, the position buttons 37 can be pressed elastically. The two handles 32 are installed in the two ends of the transversal tube 33. An elastic strip passes through the transversal tube 33. Two positioning via holes 331 with sizes slightly larger than the position buttons 37 are formed on the predetermined positions of the transversal tube 33. The two position buttons 37 are buckled in the positioning via holes 331 and thus are positioned therein. When the position button 37 is pressed, the handle 32 may separate with the transversal tube 33 so as to achieve the goal of the folding and storage referring to FIGS. 2 and 3).

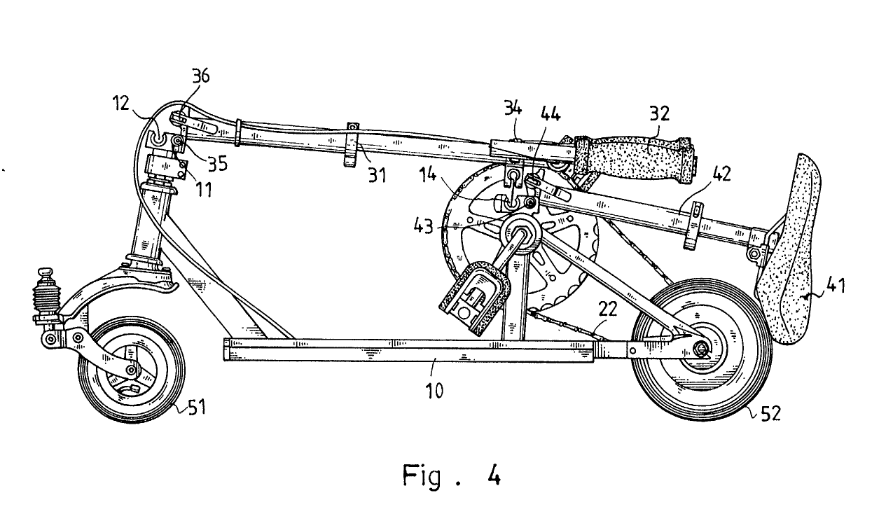

Moreover, one end of the frame body 10 with respect to the control unit 30 is formed with a pivotal hole 11 and an opening hole 12. The pivotal hole 11 has a sealed structure for being inserted by the locking screw 35. The opening hole 15 has an opening structure for being inserted by the quick-detaching screw 36. The locking screw 35 serves to pivotally lock the frame body 10 to the telescopic rod 31 by a fixing way. The quick-detaching screw 36 serves to separably and pivotally engage the frame body 10 with the telescopic rod 31. Thereby, the control unit 30 can be bent with respect to the frame body 10 through an angle (referring to FIG. 4).

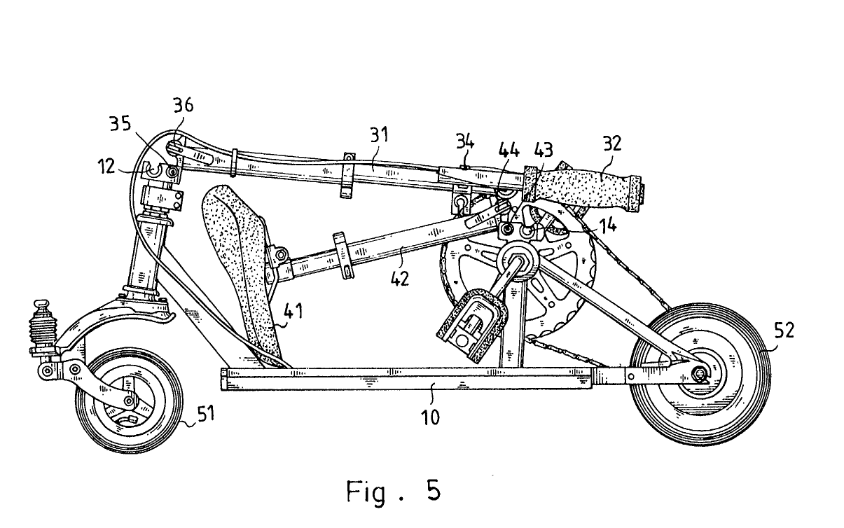

The cushion unit 40 is formed by a cushion body 41 and a cushion rod 42. The cushion rod 32 is a telescopic and foldable rod. The end of the cushion rod 32 with respect to the frame body 10 is installed with a second locking screw 43 and a second quick-detaching screw 44. The end of the frame body 10 with respect to the cushion rod 32 has a second pivotal hole 13 and a second opening hole 14. The second pivotal hole 13 serves for being installed by the second locking screw 43 so as to pivotally lock the frame body 10 to the cushion rod 42. The second opening hole 14 serves to being inserted by the second quick-detaching screw 44 so as to separably and pivotally engage the frame body 10 with the cushion rod 42. Thereby, the cushion unit 40 can be bent with respect to the frame body 10 through an angle (referring to FIGS. 4 and 5).

By above components, the present invention can be operated easily so that the telescopic rod 31, handle body 32 and cushion rod 42 are folded quickly.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bicycle capable of being folded twice for storage and carrying comprising a frame body, a chain driving unit, a control unit, and a cushion unit; the frame body having a front wheel, a rear wheel, pedals; the control unit being in front of the frame body for controlling the moving direction of the bicycle; and the cushion unit being installed at a middle section the frame body; characterized in that:
the control unit has a telescopic rod and two handles; the two handles are elastically buckled in a telescopic tube at a top of the telescopic rod; an elastic stripe passes through the telescopic rod; one end of the telescopic rod is pivotally installed to one end of the frame body and is formed with a locking screw and a quick-detaching screw; one end of the frame body with respect to the control unit is formed with a pivotal hole and an opening hole; the pivotal hole is inserted by the locking screw; the opening hole is inserted by the quick-detaching screw; the locking screw serves to pivotally lock the frame body and the telescopic rod so that the frame body and the telescopic rod are fixed and pivotally connected with one another; the quick-detaching screw serves to separably and pivotally engage the frame body and the telescopic rod; whereby, the control unit can be bent with respect to the frame body through an angle.

2. The bicycle capable of being folded twice for storage and carrying as claimed in claim 1, wherein the cushion unit is formed by a cushion body and a cushion rod; the cushion rod is a telescopic and foldable rod; one end of the cushion rod with respect to the frame body is installed with a second locking screw and a second quick-detaching screw; one end of the frame body with respect to the cushion rod has a second pivotal hole and a second opening hole; the second pivotal hole is inserted by the second locking screw so as to pivotally lock the frame body and the cushion rod; the second opening hole is inserted by the second quick-detaching screw so as to separably and pivotally engage the frame body and the cushion rod; thereby, the cushion unit can be bent with respect to the frame body through an angle.

3. The bicycle capable of being folded twice for storage and carrying as claimed in claim 1, wherein the two handles have respective position buttons at predetermined positions; an inner surface of each position button is resisted by an elastomer; thereby, the position buttons are pressed elastically; two positioning via holes with sizes slightly larger than those of the position buttons are formed on predetermined positions of the transversal tube; the two position buttons are buckled in the positioning via holes and thus are positioned therein; wherein when the position button is pressed, the handle is separated with the transversal tube so as to be folded for storage and carrying.

4. The bicycle capable of being folded twice for storage and carrying as claimed in claim 1, wherein two positioning bodies are positioned at predetermined positions in that the telescopic rod is adjacent to the telescopic rod for placing the two handles as the two handles are separated with the telescopic rod.

5. The bicycle capable of being folded twice for storage and carrying as claimed in claim 3, wherein two positioning bodies are positioned at predetermined positions in that the telescopic rod is adjacent to the telescopic rod for placing the two handles as the two handles are separated with the telescopic rod.
